(19) United States
(12) Patent Application Publication
(10) Pub. No.: US 2025/0314674 A1
(43) Pub. Date: Oct. 9, 2025

(54) QUALITY MEASUREMENT APPARATUS

(71) Applicant: Yanmar Holdings Co., Ltd., Osaka (JP)

(72) Inventor: Fumihiko NAKASAKO, Itami (JP)

(73) Assignee: Yanmar Holdings Co., Ltd., Osaka (JP)

(21) Appl. No.: 19/098,770

(22) Filed: Apr. 2, 2025

(30) Foreign Application Priority Data
Apr. 3, 2024 (JP) 2024-059979
Jan. 28, 2025 (JP) 2025-012158

(51) Int. Cl. G01N 35/04

(52) U.S. Cl. CPC G01N 35/04; G01N 2035/0424; G01N 2035/0425; G01N 2035/0496

(57) ABSTRACT

A quality measurement apparatus for measuring a quality of fruits and vegetables placed on a storage tray has a first conveying portion for conveying the storage tray, a first-surface measuring portion for measuring the fruits and vegetables in the storage tray from above in the first conveying portion, a tray inverting portion for performing an inverting operation for inverting the storage tray carried in from the first conveying portion in a vertical direction and carrying out the storage tray after the inverting operation, a second conveying portion for conveying the storage tray after the inverting operation, which was carried out from the tray inverting portion, a tray removing portion for removing the storage tray above the fruits and vegetables in the second conveying portion, and a second-surface measuring portion for measuring the fruits and vegetables from above in a state in which the storage tray above is removed in the second conveying portion.

### TECHNICAL FIELD

The present disclosure relates to a quality measurement apparatus that measures quality of an object to be measured (such as fruits and vegetables) accommodated in a tray.

### BACKGROUND ART

Patent Document 1 describes a sorting system for sorting fruits and vegetables by placing a plurality of fruits and vegetables on a tray, irradiating the fruits and vegetables in the tray with X-rays, and measuring classes of the fruits and vegetables.

### PRIOR ART DOCUMENT

### Patent Document

Patent Document 1: Japanese Patent No. 6861175

### SUMMARY OF INVENTION

### Technical Problem

In the measurement by X-ray irradiation as in Patent Document 1, a flaw or the like on the surface of a fruit or a vegetable cannot be measured by measurement by X-ray irradiation, and the flaw or the like needs to be visually determined. In addition, in the surface-measurement sorting system using the tray, if the upper surface of the fruit or vegetable is imaged by a camera or the like, it is possible to measure a flaw or the like of a plurality of fruits or vegetables at a time. However, in this case as well, a placement surface side of the tray (the rear surface side of the fruit or vegetable) is a blind spot from the camera and cannot be imaged.

That is, in the prior art, it is impossible to measure the quality of the entire surface (the upper surface and the back surface) of the fruit or vegetable accommodated in the tray, and it is necessary to rely on visual sorting or the like, which lowers the sorting efficiency and hinders complete automation.

The present disclosure was made in view of the above-described problem, and an object of the present disclosure is to provide a quality measurement apparatus capable of measuring the entire surface (the upper surface and the back surface) of an object to be measured such as fruit or vegetable accommodated in a tray.

### Solution to Problem

In order to solve the above-described problem, the quality measurement apparatus of the present disclosure is a quality measurement apparatus for measuring quality of an object to be measured placed on a storage tray, including: a first conveying portion for conveying the storage tray; a first-surface measuring portion for measuring the object to be measured in the storage tray from above in the first conveying portion; a tray inverting portion for performing an inverting operation of vertically inverting the storage tray carried in from the first conveying portion and carrying out the storage tray after the inverting operation; a second conveying portion for conveying the storage tray after the inverting operation, carried out from the tray inverting portion; a tray removing portion for removing the storage tray above the object to be measured in the second conveying portion; and a second-surface measuring portion for measuring the object to be measured from above in a state in which the storage stray above was removed in the second conveying portion.

According to the above-described configuration, the measurement operation by the first-surface measuring portion and the measuring operation by the second-surface measuring portion are performed with the inversing operation by the tray inverting portion interposed therebetween and thus, it is possible to automate the entire-surface measurement on the object to be measured, which is accommodated in the storage tray.

In addition, the above-described quality measurement apparatus may be configured such that the tray inverting portion is disposed between the first conveying portion and the second conveying portion.

According to the above-described configuration, in the quality measurement apparatus, it is possible to simultaneously convey a plurality of storage trays and thus, work efficiency is improved.

In addition, in the quality measurement apparatus, the storage tray includes a first tray and a second tray which is disposed inside the first tray and in which concave portions on which the objects to be measured are placed are regularly formed, and in the first conveying portion, a second-tray supplying portion which is disposed on a downstream side in a conveying direction of the first-surface measuring portion and further supplies a second tray so as to cover an upper surface of the object to be measured in the storage tray is provided, in which the tray inverting portion performs an inverting operation in a state in which the object to be measured in the storage tray is sandwiched by the two second trays, and the tray removing portion, in the second conveying portion, can be configured such that the first tray and one of the second trays located above the object to be measured are removed.

According to the above-described configuration, in the inverting operation of the tray inverting portion, the object to be measured in the storage tray is sandwiched by the two second trays and thus, deviation of the object to be measured in the storage tray is suppressed. As a result, the object to be measured in the storage tray is accurately inverted by the inverting operation, and the measurement accuracy is improved.

In addition, the above-described quality measurement apparatus can be configured such that quality information obtained by the measurement by the first-surface measuring portion and quality information obtained by the measurement by the second-surface measuring portion are managed in an integrated manner for each object to be measured.

According to the above-described configuration, the quality information can be individually managed for each of the objects to be measured in the storage tray, and the quality information can be easily used in a subsequent sorting step (a step of sorting the objects to be measured on the basis of the quality information).

In addition, in the above-described quality measurement apparatus, the tray removing portion may be configured to have a suction conveying portion that causes a negative pressure to act to an upper surface of the storage tray and removes the storage tray.

In addition, in the quality measuring apparatus, the storage tray may include a first tray and a second tray, which is disposed inside the first tray and in which concave portions on which the objects to be measured are placed are regularly formed, a plurality of vent holes are formed in a bottom plate of the first tray, and the suction conveying portion may be configured to cause a negative pressure to act also to the second tray through the vent holes so that the first tray and the second tray can be suctioned at the same time.

### Advantageous Effects of Invention

The quality measurement apparatus of the present disclosure exerts such an effect that the entire surface measurement for the object to be measured, accommodated in the storage tray, can be automated, whereby the measurement accuracy and the work efficiency can be improved.

### BRIEF DESCRIPTION OF DRAWINGS

FIG. 1 is a schematic configuration diagram of a quality measurement apparatus according to a first Embodiment.

FIG. 2 is a diagram of an inner-tray supplying portion as viewed from a conveying direction side of a first conveying portion.

FIG. 3 is a diagram of a tray removing portion as viewed from a conveying direction side of a second conveying portion.

FIG. 4 is an explanatory view illustrating a state in which a storage tray is conveyed from the first conveying portion to a tray inverting portion.

FIG. 5 is an explanatory view illustrating a state in which holding of the storage tray in the tray inverting portion is performed by a pressing mechanism.

FIG. 6 is an explanatory view illustrating a state in which the tray inverting portion performs an inverting operation.

FIG. 7 is an explanatory view illustrating a state of the tray inverting portion after the inverting operation was finished.

FIG. 8 is an explanatory view illustrating a state in which holding by the pressing mechanism of the storage tray in the tray inverting portion after the inverting operation is released.

FIG. 9 is an explanatory view illustrating a state in which the inverted storage tray is conveyed from the tray inverting portion to the second conveying portion.

FIG. 10 is a plan view illustrating a schematic configuration of the tray inverting portion, in which one of inverting conveyors and the pressing mechanism are viewed from a conveying surface side.

FIG. 11 is a block diagram illustrating a control system of a quality measurement apparatus.

FIG. 12 is a schematic configuration diagram of the quality measurement apparatus in a second Embodiment.

FIG. 13 is a plan view of an outer tray.

### DESCRIPTION OF EMBODIMENTS

### First Embodiment

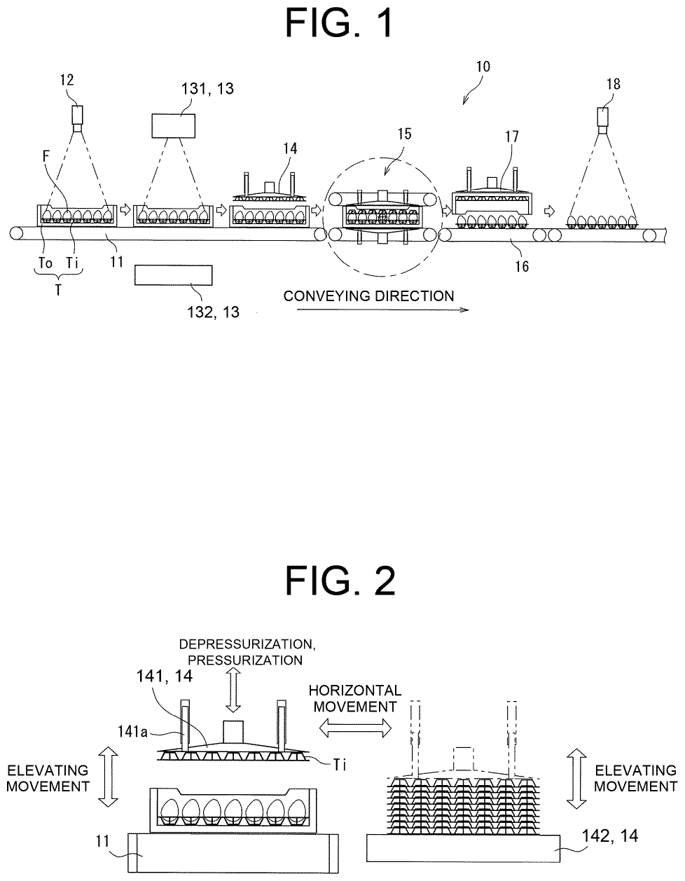

In the following, Embodiments of the present disclosure will be described in detail with reference to the drawings. FIG. 1 is a schematic configuration diagram of a quality measurement apparatus 10 illustrating an Embodiment of the present disclosure. The quality measurement apparatus 10 performs quality measurement of fruits and vegetables F, while conveying the fruits and vegetables F (for example, fruits such as strawberries), which are objects to be measured, in a state accommodated in a storage tray T. As shown in FIG. 1, the quality measurement apparatus 10 includes a first conveying portion 11, a first-surface measuring portion 12, an X-ray measuring portion 13, an inner-tray supplying portion (second-tray supplying portion) 14, a tray inverting portion 15, a second conveying portion 16, a tray removing portion 17, and a second-surface measuring portion 18.

The first conveying portion 11 conveys the storage tray T on an upstream side in a conveying direction with respect to the tray inverting portion 15, and for example, a conveyor device such as a belt conveyor, a roller conveyor or the like is used. The storage tray T of this Embodiment includes an outer tray (first tray) To and an inner tray (second tray) Ti disposed inside the outer tray To. In the inner tray Ti, a plurality of concave portions are formed regularly (for example, in a matrix form). The fruits and vegetables F are placed on the concave portions of the inner tray Ti, and the plurality of fruits and vegetables F are accommodated (placed) in the storage tray T in a regularly disposed state.

In FIG. 1, the first conveying portion 11 is described as one conveyor device, but the first conveying portion 11 may be configured by a plurality of conveyor devices. In a conveyance area by the first conveying portion 11, the first-surface measuring portion 12, the X-ray measuring portion 13, and the inner-tray supplying portion 14 are disposed.

The first-surface measuring portion 12 is an imaging device such as a camera disposed above the conveyance path of the first conveying portion 11 and performs measurement of the fruits and vegetables F accommodated in the storage tray T from above. That is, the first-surface measuring portion 12 is capable of imaging upper surfaces of all the fruits and vegetables F accommodated in one unit of the storage tray T all at once.

The X-ray measuring portion 13 includes an X-ray generating portion 131 and an X-ray receiving portion 132, either one of the X-ray generating portion 131 and the X-ray receiving portion 132 (the X-ray generating portion 131 in FIG. 1) is disposed above the conveyance path of the first conveying portion 11, and the other (the X-ray receiving portion 132 in FIG. 1) is disposed below the conveyance path. The X-ray measuring portion 13 is capable of X-ray photographing of all the fruits and vegetables F accommodated in the storage tray T.

Note that the X-ray measuring portion 13 is not an indispensable constitution in the quality measurement apparatus 10 of the present disclosure, and may be omitted. When the X-ray measuring portion 13 is provided in the quality measurement apparatus 10, the disposition order of the X-ray measuring portion 13 and the first-surface measuring portion 12 may be switched. In addition, when the X-ray measuring portion 13 is provided, a conveyor device (for example, a belt conveyor using a conveyor belt made of a resin) capable of transmitting X-rays in an X-ray photographing area is used as the first conveying portion 11.

The inner-tray supplying portion 14 is disposed on the downstream side in the conveying direction with respect to the first-surface measuring portion 12 and supplies the inner tray Ti to the storage tray T for which the imaging by the first-surface measuring portion 12 is finished so as to cover the upper surface of the fruits and vegetable F. As a result, the fruits and vegetables F in the storage tray T are sandwiched between the two inner trays Ti from above and below. Note that the inner tray Ti supplied later by the inner-tray supplying portion 14 may be the same as or different from the inner tray Ti disposed in the outer tray To from the beginning. For example, the inner tray Ti supplied later can have rigidity higher than that of the inner tray Ti disposed beforehand.

FIG. 2 is a diagram of the inner-tray supplying portion 14 viewed from the conveying direction side of the first conveying portion 11. As shown in FIG. 2, the inner-tray supplying portion 14 includes a suction conveying portion 141 which suctions and conveys the inner tray Ti, and a tray stack portion 142 on which a plurality of inner trays Ti (tray bundle) in a stacked state are placed. The tray stack portion 142 is disposed beside the first conveying portion 11. The suction conveying portion 141 functions as an air chamber that performs suctioning/suctioning release of the tray by depressurization and pressurization from the outside. In addition, the suction conveying portion 141 is capable of elevating movement by an elevation cylinder 141a and is capable of horizontal movement by a moving mechanism, not shown. The suction conveying portion 141 performs the supplying operation of the inner tray Ti by the following operation.

First, the suction conveying portion 141 moves to above the tray stack portion 142 and then, lowers to a position at which the lower surface of the suction conveying portion 141 is brought into contact with the upper surface of the tray bundle. The suction conveying portion 141 performs suction by applying a negative pressure to the upper surface of the tray (depressurizing the air chamber) in this state and suctions the uppermost inner tray Ti in the tray bundle. The suction conveying portion 141 which suctioned the inner tray Ti lifts the suctioned inner tray Ti from the tray bundle by the upward movement and further moves it above the first conveying portion 11 by the horizontal movement. The suction conveying portion 141 moves downward in a state in which the storage tray T that receives the supply of the inner tray Ti is present immediately below the suction conveying portion 141 and positions the inner tray Ti so as to cover the upper surfaces of the fruits and vegetables F in the storage tray T. In this state, the suction conveying portion 141 releases the suction holding of the inner tray Ti (pressurizing the air chamber) and supplies the inner tray Ti into the storage tray T. Thereafter, the suction conveying portion 141 returns to the initial position (above the tray stack portion 142) by the elevating movement and the horizontal movement and repeats the above-described operation.

The storage tray T which receives the supply of the inner tray Ti by the inner-tray supplying portion 14 is sent to the tray inverting portion 15 and is inverted in the vertical direction by the tray inverting portion 15. The configuration and the operation of the tray inverting portion 15 will be described later.

The second conveying portion 16 conveys the storage tray T on the downstream side in the conveying direction with respect to the tray inverting portion 15, and, for example, a conveyor device such as a belt conveyor, a roller conveyor or the like is used. Note that, on the second conveying portion 16, the direction of the fruits and vegetables F in the vertical direction is also inverted with respect to the direction on the first conveying portion 11 by the inverting operation of the tray inverting portion 15. However, in this Embodiment, for convenience of explanation, a surface on the upper side (facing upward) in the first conveying portion 11 is referred to as an upper surface of the fruit or vegetable F, and a surface on the lower side (facing downward) in the first conveying portion 11 is referred to as a rear surface of the fruit or vegetable F. That is, on the second conveying portion 16, the rear surface of the fruit or vegetable F is on the upper side. In a conveyance area by the second conveying portion 16, the tray removing portion 17 and the second-surface measuring portion 18 are disposed.

The tray removing portion 17 removes the storage tray T disposed above the fruits and vegetables F by inversion in the vertical direction. As a result, the fruits and vegetables F are placed only on the inner tray Ti supplied by the inner-tray supplying portion 14, and the rear surfaces of the fruits and vegetables F are exposed upward.

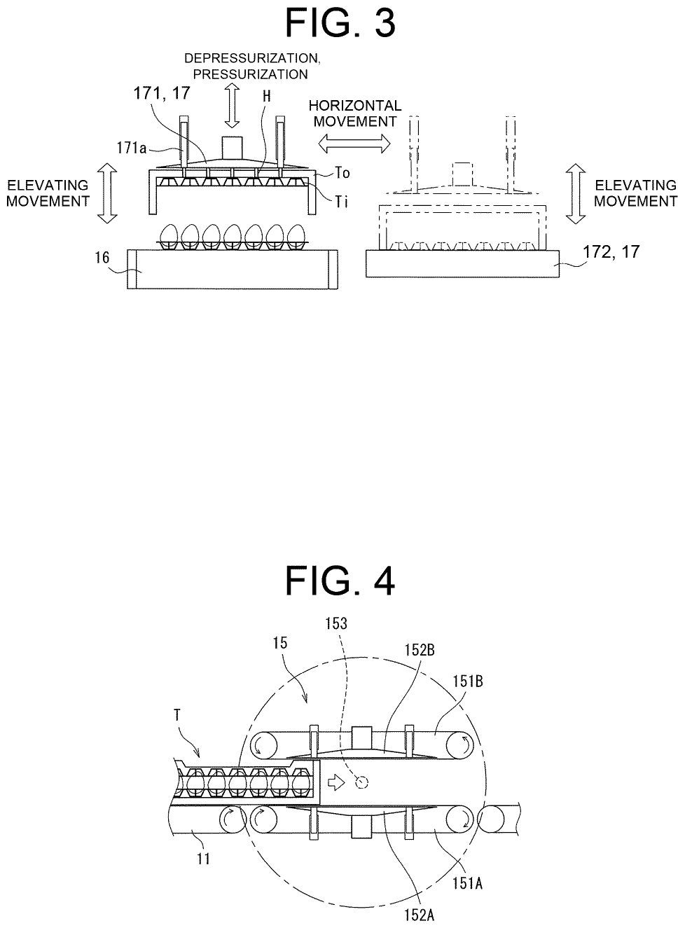

FIG. 3 is a view of the tray removing portion 17 as viewed from the conveying direction side of the second conveying portion 16. As shown in FIG. 3, the tray removing portion 17 has a suction conveying portion 171 which suctions and conveys the storage tray T (the outer tray To and the inner tray Ti), and a tray discharging portion 172 on which the removed storage tray T is discharged. The tray discharging portion 172 is disposed beside the second conveying portion 16. The suction conveying portion 171 has basically the same configuration as the suction conveying portion 141 of the inner-tray supplying portion 14 and functions as an air chamber that performs suctioning/suctioning release of the tray by depressurization and pressurization from the outside. That is, the suction conveying portion 171 is capable of elevating movement by the elevating cylinder 171a and is capable of horizontal movement by a moving mechanism, not shown. The suction conveying portion 171 performs the removing operation of the storage tray T by the following operation.

First, the suction conveying portion 171 moves to above the storage tray T conveyed to a predetermined position of the second conveying portion 16 and then, lowers to a position at which the lower surface of the suction conveying portion 171 is brought into contact with the upper surface (the bottom surface facing upward due to the inversion) of the outer tray To. In this state, the suction conveying portion 171 performs suction by applying a negative pressure to the upper surface of the tray and suctions the storage tray T. In this Embodiment, a plurality of vent holes are formed in the bottom plate of the outer tray To, and a negative pressure is caused to act also to the inner tray Ti through the vent holes (depressurizing the air chamber) so that the outer tray To and the inner tray Ti can be simultaneously suctioned. The suction conveying portion 171 which suctioned the storage tray T lifts the suctioned storage tray T by the upward movement and further moves it to above the tray discharging portion 172 by the horizontal movement. The suction conveying portion 171 releases the suction holding of the storage tray T (pressurizing the air chamber) above the tray discharging portion 172 and discharges the storage tray T onto the tray discharging portion 172. The suction conveying portion 171 may release the suction holding of the storage tray T after performing the lowering operation as necessary. Thereafter, the suction conveying portion 171 returns to the initial position (above the second conveying portion 16) by the elevating movement and the horizontal movement and repeats the above-described operation.

Note that, in the above-described explanation, the tray removing portion 17 is assumed to perform simultaneous suctioning of the outer tray To and the inner tray Ti and to remove them in the same process. In order to realize this, in the bottom plate of the outer tray To, a vent hole H penetrating the bottom plate is provided. As shown in FIG. 13, the vent holes H are preferably disposed in plural in an appropriately distributed manner. By providing the vent holes H in the bottom plate of the outer tray To, a negative pressure acts on the bottom surface of the outer tray To and the bottom surface of the inner tray Ti, when the air chamber in the suction conveying portion 171 is depressurized, and the outer tray To and the inner tray Ti can be lifted at the same time.

However, the removal of the outer tray To and the inner tray Ti does not necessarily have to be performed in the same process but may be performed in different processes. That is, it may be so configured that the suction conveying portion 171 is disposed in two stages, and first, the outer tray To is removed and subsequently, the inner tray Ti is removed.

The second-surface measuring portion 18 is an imaging device such as a camera disposed above the conveyance path of the second conveying portion 16 and measures the fruits and vegetables F accommodated in the storage tray T from above in the same manner as the first-surface measuring portion 12. In the second conveying portion 16, since the rear surfaces of the fruits and vegetables F face upward due to the inverting operation, the second-surface measuring portion 18 can image the rear surfaces of all the fruits and vegetables F placed on one inner tray Ti at once.

Subsequently, the configuration and operation of the tray inverting portion 15 will be described with reference to FIGS. 4 to 9. As shown in FIGS. 4 to 9, the tray inverting portion 15 includes a first inverting conveyor 151A, a second inverting conveyor 151B, a first pressing mechanism 152A, and a second pressing mechanism 152B. Note that the first inverting conveyor 151A and the second inverting conveyor 151B have the same configuration and operation and are simply referred to as an inverting conveyor 151 when they are not particularly distinguished from each other. The first pressing mechanism 152A and the second pressing mechanism 152B have the same configuration and operation and are simply referred to as a pressing mechanism 152 when they are not particularly distinguished from each other.

Note that, though the positions of the first inverting conveyor 151A and the second inverting conveyor 151B and the positions of the first pressing mechanism 152A and the second pressing mechanism 152B in the vertical direction are alternately switched for each inverting operation of the tray inverting portion 15, the following explanation exemplifies an inverting operation from a state in which the first inverting conveyor 151A and the first pressing mechanism 152A are on the lower side and the second inverting conveyor 151B and the second pressing mechanism 152B are on the upper side. In FIGS. 4 to 9, a reference numeral 153 denotes a rotation shaft when the tray inverting portion 15 performs the inverting operation.

FIG. 4 illustrates a state in which the storage tray T is conveyed (carried in) from the first conveying portion 11 to the tray inverting portion 15. At this time, in the tray inverting portion 15, at least the first inverting conveyor 151A (the inverting conveyor 151 located on the lower side) is driven in the conveying direction together with the first conveying portion 11. On the other hand, the second inverting conveyor 151B (the inverting conveyor 151 located on the upper side) may be driven in the conveying direction together with the first inverting conveyor 151A, or does not have to be driven. More specifically, in a case where the upper surface of the storage tray T comes into contact with the second inverting conveyor 151B, it is preferable that the second inverting conveyor 151B is driven in the conveying direction or is driven to rotate by the contact with the storage tray T. When the upper surface of the storage tray T does not come into contact with the second inverting conveyor 151B, the second inverting conveyor 151B does not have to be driven.

The pressing mechanism 152 is movable in a direction orthogonal to the conveyance surface of the inverting conveyor 151. Note that, at the movement of the pressing mechanism 152, since the conveyance surface of the inverting conveyor 151 is parallel to the horizontal direction, the pressing mechanism 152 moves in the vertical direction. In addition, a movement range of the pressing mechanism 152 includes both ranges of the inner side (the side opposite to the contact surface of the storage tray T) and the outer side (the contact surface side of the storage tray T) with respect to the conveyance surface (the contact surface with the storage tray T) of the inverting conveyor 151. In the state of FIG. 4, the pressing mechanism 152 is located outside the conveyance surface of the inverting conveyor 151, and the conveyance of the storage tray T from the first conveying portion 11 to the tray inverting portion 15 is not hindered by the pressing mechanism 152. At this time, the upper surface of the first pressing mechanism 152A on the lower side may be in contact with the conveyance rear surface (the surface on the side opposite to the contact surface of the storage tray T) of the inverting conveyor 151 or may be separated therefrom.

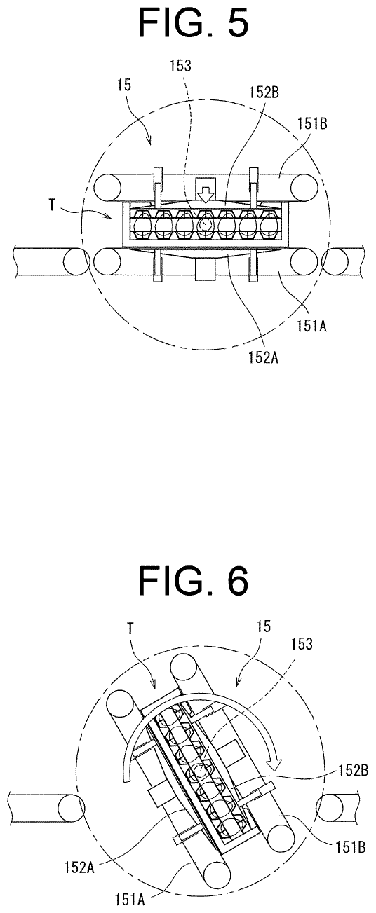

FIG. 5 illustrates a state in which the pressing mechanism 152 holds the storage tray T in the tray inverting portion 15. At this time, in the tray inverting portion 15, the second pressing mechanism 152B (the pressing mechanism 152 located on the upper side) moves downward to the inner side of the conveyance surface of the inverting conveyor 151, and the lower surface of the second pressing mechanism 152B (the pressing surface of the storage tray T) comes into contact with the inner tray Ti on the upper side of the fruits and vegetables F. More specifically, the second pressing mechanism 152B is lowered to such an extent that the inner tray Ti on the upper side is brought into close contact with the fruits and vegetables F. In addition, in a case where the first pressing mechanism 152A on the lower side is separated from the conveyance rear surface of the inverting conveyor 151 in the state of FIG. 4, the first pressing mechanism 152A moves upward to a position at which the first pressing mechanism 152A comes into contact with the conveyance rear surface of the inverting conveyor 151. As a result, the storage tray T is brought into contact with both the first pressing mechanism 152A and the second pressing mechanism 152B, and is brought into such a state of being sandwiched and held by the pressing mechanism 152 in the vertical direction.

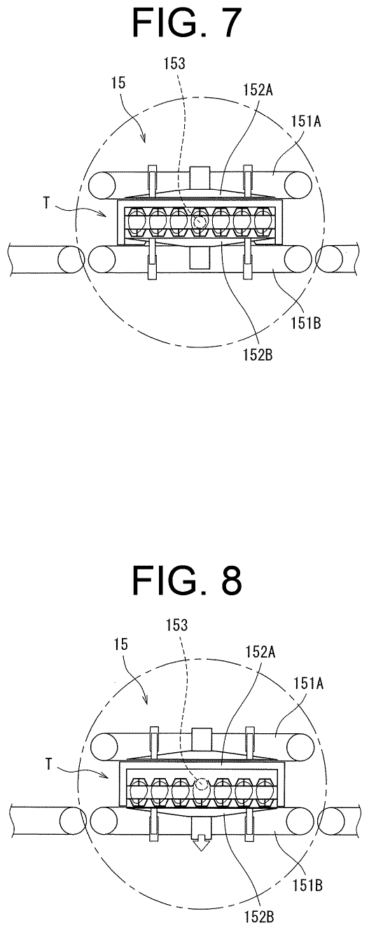

FIG. 6 illustrates a state in which the tray inverting portion 15 performs the inverting operation. FIG. 7 illustrates a state of the tray inverting portion 15 after the inverting operation is finished. As shown in FIG. 6 and FIG. 7, in this inverting operation, the tray inverting portion 15 performs 180° rotation around the rotation shaft 153. As a result, a positional relationship between the first inverting conveyor 151A and the second inverting conveyor 151B and the positional relationship between the first pressing mechanism 152A and the second pressing mechanism 152B are vertically inverted. Note that the direction of rotation in the inverting operation of the tray inverting portion 15 is not particularly limited, and, for example, the direction of rotation may be alternately reversed every time the inverting operation is performed.

By means of the inverting operation of the tray inverting portion 15, the storage tray T held by the tray inverting portion 15 is also inverted vertically. At this time, since the fruits and vegetables F in the storage tray T are sandwiched between the two inner trays Ti by the pressing mechanism 152 so as to be in close contact with the inner trays Ti, the fruits and vegetables F are not subjected to relative displacement with respect to the storage tray T (such as displacement of the fruits and vegetables F in the storage tray T). As a result, the rear surfaces of the fruits and vegetables F in the storage tray T are accurately directed upward by the inverting operation of the tray inverting portion 15, and the measurement accuracy is improved.

FIG. 8 illustrates a state in which the holding of the storage tray T by the tray inverting portion 15 after the inverting operation by the pressing mechanism 152 is released. At this time, in the tray inverting portion 15, the second pressing mechanism 152B (the pressing mechanism 152 located on the lower side) moves downward to the outside of the conveyance surface of the second inverting conveyor 151B. With that, the storage tray T is also lowered at the same time, and the storage tray T comes into contact with the conveyance surface of the second inverting conveyor 151B. At this time, the first pressing mechanism 152A on the upper side may also be moved upward to such an extent that the first pressing mechanism 152A is separated from the conveyance rear surface of the first inverting conveyor 151A.

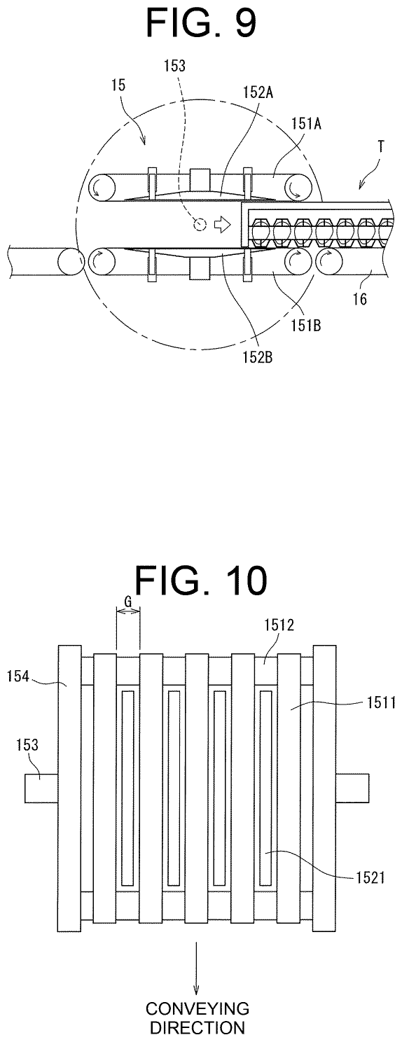

FIG. 9 illustrates a state in which the inverted storage tray T is conveyed (carried out) from the tray inverting portion 15 to the second conveying portion 16. At this time, in the tray inverting portion 15, at least the second inverting conveyor 151B (the inverting conveyor 151 located on the lower side) is driven in the conveying direction together with the second conveying portion 16. On the other hand, the first inverting conveyor 151A (the inverting conveyor 151 located on the upper side) may be or does not have to be driven in the conveying direction together with the second inverting conveyor 151B.

FIG. 10 illustrates a schematic configuration of the tray inverting portion 15 and is a plan view of the one inverting conveyors 151 and the one pressing mechanisms 152 as viewed from the conveyance surface side. As shown in FIG. 10, the inverting conveyor 151 is a belt conveyor in which a plurality of conveyor belts 1511 are extended between two roller members 1512. The plurality of conveyor belts 1511 are disposed along a width direction (a direction orthogonal to the conveying direction on the conveyance surface) with a gap G between the adjacent belts. For example, in the two roller members 1512, it is assumed that, for example, one is a driving roller and the other is a driven roller.

The tray inverting portion 15 includes base portions 154 on both sides in the width direction, and the roller member 1512 rotatably drives the conveyor belt 1511 in a state of being held between the two base portions 154. In addition, the rotation shaft 153 of the tray inverting portion 15 is provided to protrude on the outer side in the width direction of the base portion 154. As a result, the inverting conveyor 151 performs the above-described inverting operation by rotating together with the base portion 154.

The pressing mechanism 152 includes a plurality of lengthy pressing bars 1521 with the conveying direction as a longitudinal direction, and these pressing bars 1521 form a pressing surface of the storage tray T. Each of the pressing bars 1521 is disposed in the gap G between the conveyor belts 1511, and a width dimension of the pressing bar 1521 is set to be smaller than the gap G dimension. Thus, in the elevating movement of the pressing mechanism 152, the pressing bar 1521 can move between the inside and outside regions of the conveyance surface without interfering with the conveyance surface of the inverting conveyor 151. Note that an elevating mechanism (not shown) of the pressing bar 1521 in the pressing mechanism 152 is also fixed to and held by the base portion 154, and the pressing mechanism 152 can also rotate together with the base portion 154 and the inverting conveyor 151.

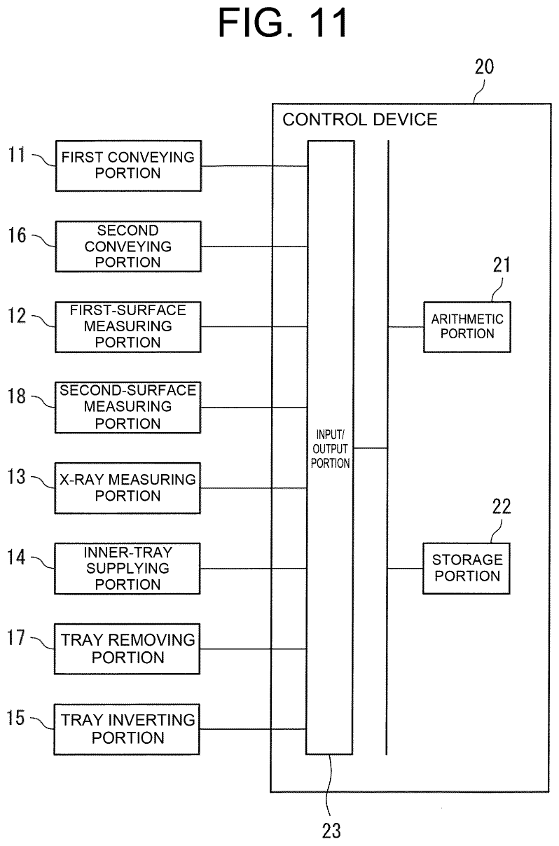

FIG. 11 is a block diagram illustrating a control system of the quality measurement apparatus 10. The quality measurement apparatus 10 includes a control device 20. The control device 20 includes an arithmetic portion 21, a storage portion 22, and an input/output portion 23. The control device 20 controls the conveying operation in the first conveying portion 11 and the second conveying portion 16, the measuring operation in the first-surface measuring portion 12, the second-surface measuring portion 18, and the X-ray measuring portion 13, the tray conveying operation in the inner-tray supplying portion 14 and the tray removing portion 17, the inverting operation and the conveying operation in the tray inverting portion 15, and the like.

The arithmetic portion 21 includes, for example, a processor such as a Central Processing Unit (CPU) or an Application Specific Integrated Circuit (ASIC), and executes arithmetic processing based on a computer program. The storage portion 22 stores data and a computer program, for example. For example, the storage portion 22 can temporarily store data needed for each processing of the arithmetic portion 21. The storage portion 22 may include a main storage device and an auxiliary storage device and may include, for example, a non-volatile memory, a hard disk drive, or the like. To the input/output portion 23, the first conveying portion 11, the first-surface measuring portion 12, the X-ray measuring portion 13, the inner-tray supplying portion 14, the tray inverting portion 15, the second conveying portion 16, the tray removing portion 17, and the second-surface measuring portion 18 are connected.

As the measuring operation of the quality measurement apparatus 10, the arithmetic portion 21 executes image processing on the imaging data in the first-surface measuring portion 12 and the second-surface measuring portion 18, and determines presence/absence or the like of a flaw on the surface of the fruit or vegetable F. More specifically, the presence or absence of a flaw on the upper surface of the fruit or vegetable F is determined from the imaging data of the first-surface measuring portion 12, and the presence or absence of a flaw on the rear surface of the fruit or vegetable F is determined from the imaging data of the second-surface measuring portion 18. In addition, the quality information obtained from the measuring operation by the first-surface measuring portion 12 and the second-surface measuring portion 18 can include not only the presence/absence of a flaw but also information on the class such as the size of the fruit or vegetable F and information on the grade such as the color and the shape of the fruit or vegetable F. In addition, for example, information such as the weight of the fruit or vegetable F can be obtained from the measurement result by the X-ray measuring portion 13.

The measurement result (quality information) of each fruit or vegetable F is stored in the storage portion 22 together with tray identification information for identifying the storage tray T in which the fruit or vegetable F is accommodated and disposition position information (in-tray coordinates) of each fruit or vegetable F in the storage tray T. More specifically, in each of the fruits and vegetables F, the quality information obtained by the measurement by the first-surface measuring portion 12 and the quality information obtained by the measurement by the second-surface measuring portion 18 are stored in the storage portion 22 in an integrated state on the basis of the tray identification information and the disposition position information. As a result, the quality measurement apparatus 10 can individually manage the quality information for each of the fruits and vegetables F in the storage tray T, and the quality information can be easily used in a sorting process (a process of sorting the fruits and vegetables F on the basis of the quality information) in a subsequent stage.

As described above, the quality measurement apparatus 10 of the present disclosure can automate the entire-surface measurement on the fruits and vegetables F accommodated in the storage tray T by performing the measuring operation by the first-surface measuring portion 12 and the measuring operation by the second-surface measuring portion 18 with the inverting operation by the tray inverting portion 15 interposed therebetween. As a result, the measurement accuracy and the work efficiency can be improved. In addition, in the quality measurement apparatus 10, since the tray inverting portion 15 is disposed between the first conveying portion 11 and the second conveying portion 16, it is possible to simultaneously convey a plurality of the storage trays T and thus, work efficiency is improved.

### Second Embodiment

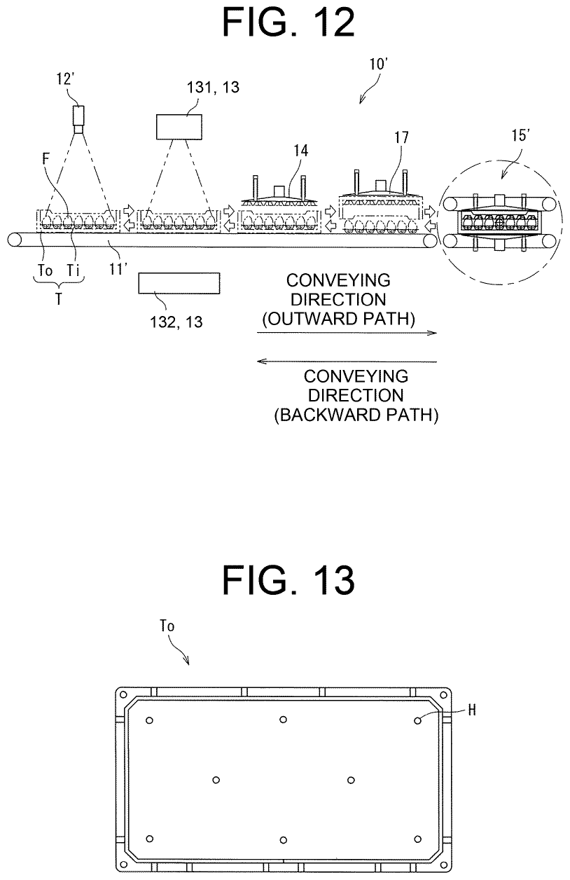

FIG. 12 is a schematic configuration diagram of a quality measurement apparatus 10′ illustrating another Embodiment of the present disclosure. As shown in FIG. 12, the quality measurement apparatus 10′ includes a conveying portion 11′, a surface measuring portion 12′, an X-ray measuring portion 13, an inner-tray supplying portion 14, a tray removing portion 17, and a tray inverting portion 15′.

The conveying portion 11′ performs conveying of the storage tray T and can perform outward conveyance and backward conveyance in which conveying directions are opposite to each other with respect to the storage tray T. That is, the conveying portion 11′ conveys the storage tray T before being subjected to the inverting operation to the tray inverting portion 15′ by the outward conveyance and conveys the storage tray T after being subjected to the inverting operation from the tray inverting portion 15′ by the backward conveyance. In addition, in the quality measurement apparatus 10′, the surface measuring portion 12′, the X-ray measuring portion 13, the inner-tray supplying portion 14, and the tray removing portion 17 are disposed in the conveyance area of the conveying portion 11′. Note that, in this Embodiment, too, the X-ray measuring portion 13 is not indispensable.

The surface measuring portion 12′ is an imaging device similar to the first-surface measuring portion 12 and the second-surface measuring portion 18 in the first Embodiment. In addition, the X-ray measuring portion 13, the inner-tray supplying portion 14, and the tray removing portion 17 have the same configurations as those in the first Embodiment. The tray inverting portion 15′ performs an inverting operation in the same manner as the tray inverting portion 15 in the first Embodiment, and furthermore, can perform outward conveyance and backward conveyance with respect to the storage tray T in the same manner as the conveying portion 11′.

In the quality measurement apparatus 10′, the surface measuring portion 12′, the X-ray measuring portion 13, and the inner-tray supplying portion 14 are operated at the time of the outward conveyance. That is, the upper surface of the fruit or vegetable F can be imaged by the surface measuring portion 12′ at the time of the outward conveyance, and the quality information of the upper surface of the fruit or vegetable F can be acquired. The storage tray T after the outward conveyance is subjected to an inverting operation by the tray inverting portion 15′ and then, subjected to the backward conveyance. At the time of the backward conveyance, the tray removing portion 17 and the surface measuring portion 12′ are operated. That is, the rear surface of the fruit or vegetable F can be photographed by the surface measuring portion 12′ at the time of the backward conveyance, and the quality information of the rear surface of the fruit and vegetable F can be acquired. That is, in the quality measurement apparatus 10′, the conveying portion 11′ is used as both the first conveying portion and the second conveying portion described in the scope of claims, and the surface measuring portion 12′ is used as both the first-surface measuring portion and the second-surface measuring portion described in the scope of claims.

Note that, since the quality measurement apparatus 10′ cannot convey a plurality of storage trays T at the same time, only the storage tray T at the right end (in the tray inverting portion 15) in FIG. 12 is indicated by a solid line, and the other storage trays T are indicated by virtual lines.

As described above, the quality measurement apparatus 10′ of this Embodiment performs the outward conveyance and the backward conveyance with the inverting operation by the tray inverting portion 15 interposed therebetween, and performs measurement by the surface measuring portion 12′ in each conveyance, whereby the entire surface measurement on the fruits and vegetables F accommodated in the storage tray T can be automated.

The Embodiments disclosed herein are illustrative in all respects and do not serve as a basis for limited interpretation. Therefore, the technical range of the present disclosure is not interpreted only by the above-described Embodiments but is defined on the basis of the description in the scope of claims.

### REFERENCE SIGNS LIST

10, 10′ Quality measurement apparatus
11 First conveying portion
11′ Conveying portion (first conveying portion, second conveying portion)
12 First-surface measuring portion
12′ Surface measuring portion (first-surface measuring portion, second-surface measuring portion)
13 X-ray measuring portion
14 Inner-tray supplying portion (second-tray supplying portion)
141 Suction conveying portion
15, 15′ Tray inverting portion
151 Inverting conveyor
152 Pressing mechanism
16 Second conveying portion
17 Tray removing portion
171 Suction conveying portion
18 Second-surface measuring portion
20 Control device
21 Arithmetic portion
22 Storage portion
T Storage tray
To Outer tray (first tray)
Ti Inner tray (second tray)
F Fruits and vegetables (object to be measured)
H Vent hole

1. A quality measurement apparatus for measuring a quality of an object to be measured, which was placed on a storage tray, comprising:
a first conveying portion that conveys the storage tray;
a first-surface measuring portion that measures the object to be measured in the storage tray from above in the first conveying portion;
a tray inverting portion that performs an inverting operation of inverting the storage tray carried in from the first conveying portion in a vertical direction and carries out the storage tray after the inverting operation;
a second conveying portion that conveys the storage tray after the inverting operation, which was carried out from the tray inverting portion;
a tray removing portion that removes the storage tray above the object to be measured in the second conveying portion; and
a second-surface measuring portion that measures the object to be measured from above in a state in which the storage tray above is removed in the second conveying portion.

2. The quality measurement apparatus according to claim 1, wherein
the tray inverting portion is disposed between the first conveying portion and the second conveying portion.

3. The quality measurement apparatus according to claim 1, wherein
the storage tray includes a first tray and a second tray, which is disposed on an inner side of the first tray and in which concave portions on which the objects to be measured are placed are regularly formed;
in the first conveying portion, a second-tray supplying portion, which is disposed on a downstream side in a conveying direction of the first-surface measuring portion and further supplies a second tray in a manner to cover an upper surface of the object to be measured in the storage tray, is provided;
the tray inverting portion performs an inverting operation in a state in which the object to be measured in the storage tray is sandwiched by two of the second trays; and
the tray removing portion removes the first tray and one of the second trays located above the object to be measured in the second conveying portion.

4. The quality measurement apparatus according to claim 1, wherein
quality information obtained by measurement by the first-surface measuring portion and quality information obtained by the measurement by the second-surface measuring portion are managed in an integrated manner for each object to be measured.

5. The quality measurement apparatus according to claim 1, wherein
the tray removing portion includes a suction conveying portion that causes a negative pressure to act to an upper surface of the storage tray to remove the storage tray by suction.

6. The quality measurement apparatus according to claim 5, wherein
the storage tray includes a first tray and a second tray, which is disposed on an inner side of the first tray and in which concave portions on which objects to be measured are placed are regularly formed;
a plurality of vent holes are formed in a bottom plate of the first tray; and
the suction conveying portion causes a negative pressure to act also to the second tray through the vent holes, to be able to suction the first tray and the second tray at the same time.
